(19) United States
(12) Patent Application Publication
(10) Pub. No.: US 2005/0210778 A1
(43) Pub. Date: Sep. 29, 2005

(54) Thick-walled window frame

(76) Inventors: Kevin A. Seiling, Monaca, PA (US); Eric M. Eisenhuth, East Butler, PA (US)

Correspondence Address: COHEN & GRIGSBY, P.C., 11 STANWIX STREET, 15TH FLOOR, PITTSBURGH, PA, 15222, US

(21) Appl. No.: 10/797,173

(22) Filed: Mar. 10, 2004

(51) Int. Cl. E06B 1/04

(52) U.S. Cl. 52/204.1

(57) ABSTRACT

A thick-walled vinyl window sash (12) wherein glazing beads (46) maintain site panels (41 and 42) against the tower (49) of four rails (10). The body (16) of each of the rails (10) includes a slot (32), and internal passageway (30), and a boring (34). The boring communicates with the slot through the internal passageway to provide a drainage path for condensation.

### BACKGROUND OF THE INVENTION

1. Field of the Invention

The subject invention relates to windows and, more particularly, vinyl windows of the type that are made of polyvinylchloride foam material.

2. Description of the Prior Art

Many types and styles of vinyl windows are known in the prior art. With many styles of vinyl windows, the components are not solid. Rather, they have an internally open structure. These windows generally allow condensation drainage through the window components without difficulty and generally without special measures.

However, some vinyl windows have been constructed of polyvinylchloride material such that they have solid-body components. Because they do not have an open internal structure, a problem with the solid-body type of vinyl window has been that the solid body members have tended to impede condensation drainage from the window. Accordingly, there was a need in the prior art for a vinyl window of the polyvinylchloride type and having a design that would allow vapor condensation to drain from the window.

### SUMMARY OF THE INVENTION

In accordance with the presently disclosed invention, a rail for use in a window sash includes a body that defines a center face and a perimeter face that is oppositely disposed from the center face. The rail body further defines an exterior lateral surface that extends between the center face and the perimeter face and an interior lateral surface that is oppositely disposed on the body from the exterior lateral surface. The body also defines an internal passageway that is located between the center face and the perimeter face and also between the exterior lateral surface and the interior lateral surface. The internal passageway extends from one longitudinal end of the rail to the opposite longitudinal end. The body further defines a slot in the center face which slot provides a pathway between the center face and the internal passageway. In this way, condensation that collects on the center face can flow through said slot and to the internal passageway. The rail body also includes a boring that defines a first opening in the internal passageway and a second opening in the perimeter face. In this way, condensation that collects on the internal passageway can flow through the boring to the perimeter surface.

Preferably, a reinforcing member is located in the internal passageway of the body to strengthen the rail to prevent sagging, bowing and other displacement caused by forces on the rail, particularly forces acting in a lateral direction.

More preferable, the body further defines a pocket for receiving a glazing bead. The pocket is located in the center face and between the external lateral surface and the slot in the center face.

Most preferably, the body defines a tower that is joined at the center face of the body and that is located adjacent to the interior lateral surface of said body such that a glazing bead in the pocket will urge a site panel that is located between the glazing bead and the tower against the tower to secure the site panels to the rail.

Other objects, advantages and features of the presently disclosed invention will become apparent to those skilled in the art as a description of a presently preferred embodiment thereof proceeds.

### BRIEF DESCRIPTION OF THE DRAWINGS

A presently preferred embodiment of the disclosed invention is shown and described in connection with the accompanying drawings in which:

FIG. 1 is a sectioned perspective view of a window sash having the mechanism for condensation drainage as disclosed herein;

FIG. 2 is a horizontal cross-section of the vinyl window of FIG. 1 taken along the lines 2-2 of FIG. 1; and

FIG. 3 is a vertical cross-section of the vinyl window of FIG. 1 taken along the lines 3-3 of FIG. 1.

### DESCRIPTION OF A PREFERRED EMBODIMENT

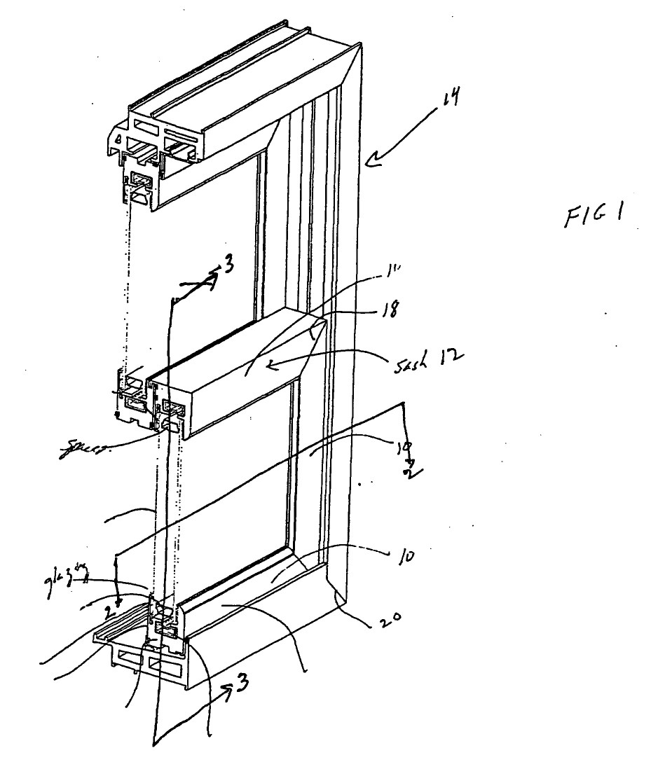

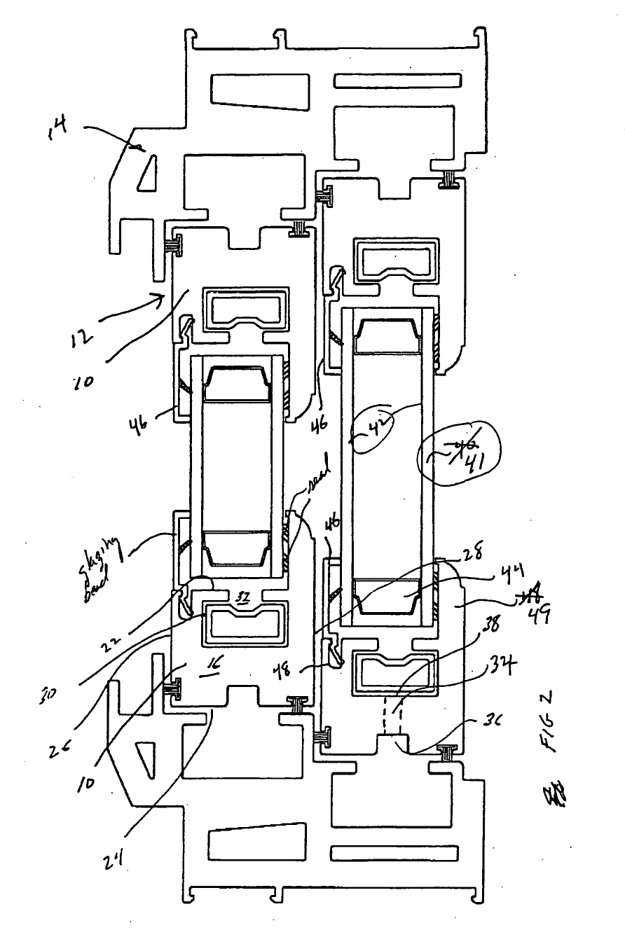

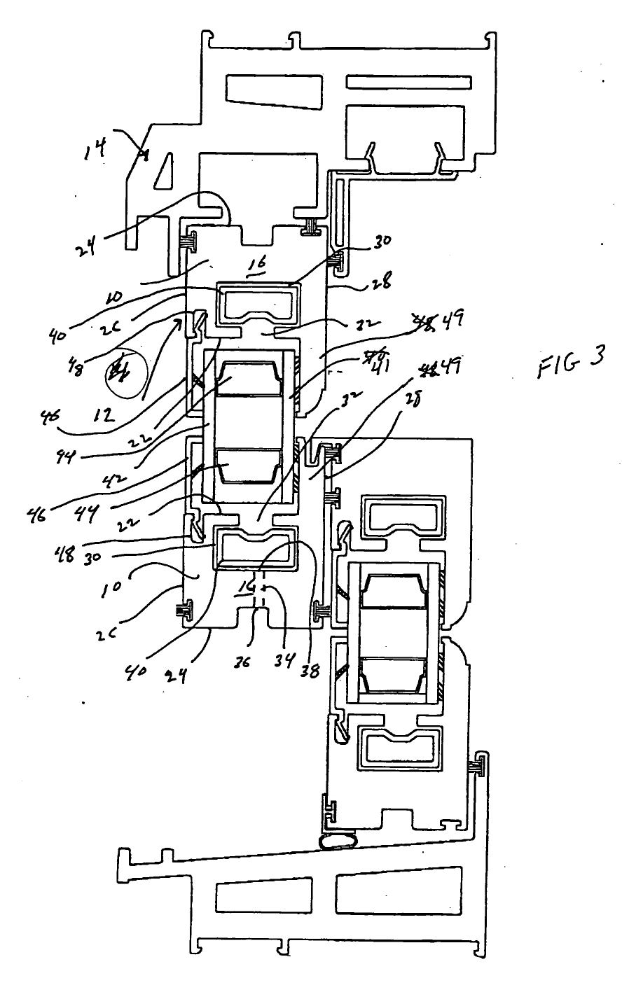

FIGS. 1-3 show a presently preferred embodiment of the invention wherein an assembly of rail styles 10 comprise a sash 12. As shown in FIGS. 1-3, sash 12 is located in a double-hung window 14, although the presently disclosed invention is also applicable to other types and styles of windows and will be apparent to those skilled in the art.

Bottom rail 10 is formed by extruding polyvinylchloride foam through an extrusion die. As is also known in the art, extruding polyvinylchloride foam in this way will provide a solid vinyl structure that has high insulating properties. However, because the mechanical strength of polyvinylchloride foam is less than that of certain other architectural-grade vinyl compositions, and because the solid composition affords no natural drainage path for condensation, bottom rail 10 is designed and constructed as further herein described.

The window sash 12 is made from an assembly of four rails. Each of the rails 10 has a generally elongated body 16 with first and second longitudinal ends 18 and 20. Each of longitudinal ends 18 and 20 is connected to the longitudinal end of another rail 10 such that the four rails 10 that compose the sash 12 are arranged in a rectangular form.

Body 16 for each of the rails 10 defines a respective center face 22. Center face 22 is so-called because when the rails 10 are assembled into a window sash 12, center face 22 faces the center of the window. Body 16 further defines a perimeter face 24 that is oppositely disposed on body 16 from the center face 22. When the rails 10 are assembled into a window sash 12, perimeter face 14 faces outwardly from the center of the window sash 12 and defines the perimeter of the sash 12.

Body 16 of rail 10 further includes an exterior lateral surface 26 that extends between the center face 22 and the perimeter face 24. Body 16 also includes an interior lateral surface 28 that is oppositely disposed on body 16 from the exterior lateral surface 28. An internal passageway 30 that extends between first longitudinal end 18 and second longitudinal end 20 is located in body 16 between the center face 22 and the perimeter face 24. Internal passageway 30 is also located between the exterior lateral surface 26 and the interior lateral surface 28.

A slot 32 that extends from first longitudinal end 18 to second longitudinal end 20 is located in center surface 22. Slot 32 opens to the internal passageway 30 so as to form a pathway between the center face 22 and the internal passageway 30. Water that collects on center face 22 will flow through slot 32 to the internal passageway 30.

Body 16 is further provided with at least one boring 34 that has one opening 36 in the perimeter face 24 and a second opening 38 in internal passageway 30. In this way, when water collects in internal passageway 30, the water flows from the internal passageway 30 through boring 34 and to the perimeter face 24 of the body 16 where it can drain away from the window.

To strengthen the rail 10, particularly against buckling or warping, rail 10 is further provided with a reinforcing member such as rectangular tube 40. After rail 10 is extruded, rectangular tube 40 is inserted into rail 10 by biasing the sides of slot 32 apart sufficiently to allow tube 40 to pass through the slot and into internal passageway 30. Tube 40, therefore, is sized so that it appropriately fits within internal passageway 30.

The rectangular form of four rails 10 that are included in sash 12 retains site panels 41 and 42. Preferably, site panels 41 and 42 are made of transparent material such as glass. Site panels 41 and 42 are separated by a spacer 44 that maintains panels 41 and 42 in spaced apart relationship from each other.

Site panels 41 and 42 are secured against the body 16 of rail 10 by respective glazing beads 46 that engage body 16 and urge the assembly of panels 41 and 42 and spacer 44 against body 16. More specifically, glazing beads 46 are insertable into a glazing bead pocket 48 that is located in the center face 22 of body 16. Glazing bead pocket 48 is located in center face 22 between external lateral surface 26 and slot 32. Glazing beads 46 engage glazing bead pocket 48 such that when glazing beads 46 are inserted in blazing bead pocket 48, glazing beads 46 are mechanically biased against site panel 42 so as to urge the assembly of site panels 41 and 42 and spacer 44 against body 16.

To oppose the bias force of glazing beads 46, the center face 22 of body 16 is provided with a tower 49. Tower 49 is joined to body 16 at the center face 22 and is located on center face 22 adjacent to the interior lateral surface 28. In this way, glazing beads 46 urge the assembly of panels 41 and 42 and spacer 44 against the respective tower 49 of rail 10.

While a presently preferred embodiment of the invention has been shown and described herein, the presently disclosed invention is not limited thereto but can be otherwise variously embodied within the scope of the following claims.

1. A rail having an elongated body of extruded cellular material, said rail body comprising:
a center face;
a perimeter face that is oppositely disposed on said body from said center face;
an exterior lateral surface that extends between said center face and said perimeter face;
an interior lateral surface that is oppositely disposed on said body from said exterior lateral surface;
an internal passageway that is located between said center face and said perimeter face and that also is located between said exterior lateral surface and said interior surface;
a slot in said center face, said slot providing a pathway between said center face and said internal passageway such that water collecting on said center face can flow through said slot to said internal passageway; and
at least one boring having one opening in said perimeter face and another opening in said internal passageway such that water collecting in said internal passageway can flow from said internal passageway through said boring to the perimeter face of said body.

2. The rail body of claim 1 and further comprising:
a reinforcing member that is located in the passageway of said body to strengthen said member.

3. The rail body of claim 2 further comprising:
a tower that is joined at the center face of said body, said tower also being located adjacent to the interior lateral surface of said body.

4. The rail body of claim 3 further comprising:
a pocket that is located in the center face of said body and laterally between the external lateral surface and said slot in said center face.

5. The rail body of claim 4 wherein said pocket is for receiving a glazing bead.

6. A window sash comprising:
a. four rails, each of said rails having an elongated solid body with first and second longitudinal ends, each of said first and second longitudinal ends being connected to a longitudinal end of another of said four rails to define a rectangular frame, the elongated body of each of said rails defining:
a center face;
a perimeter face that is oppositely disposed on said body from said center face;
an exterior lateral surface that extends between said center face and said perimeter face;
an interior lateral surface that is oppositely disposed on said body from said exterior lateral surface;
an internal passageway that is located between said center face and said perimeter face and that also is located between said exterior lateral surface and said interior lateral surface;
a slot that is located in said center surface, said slot forming a pathway between said center face and said internal passageway such that water collecting on said center face can flow through said slot to said internal passageway; and
at least one boring having one opening in said perimeter face and another opening in said internal passageway such that water collecting in said internal passageway can flow from said internal passageway through said boring to the perimeter face of said body;
b. a reinforcing member that is located in the passageway of said body to strengthen said member;
c. first and second site panels that are located within the rectangular frame that is formed by said rails;
d. a spacer for separating the site panels from each other; and
e. four glazing beads, each of said glazing beads engaging the glazing pocket of a respective one of said four rails, said glazing bead urging said site panels and said spacer against said body to secure said site panels and said spacer to said body.

7. The rail body of claim 6 and further comprising:
a reinforcing member that is located in the passageway of said body to strengthen said member.

8. The rail body of claim 7 further comprising:
a tower that is joined at the center face of said body and also being located adjacent to the interior lateral surface of said body.

9. The rail body of claim 8 wherein said glazing bead urges said site panels and said spacer against said tower.

10. The frame member of claim 6 wherein said body is comprised of polyvinylchloride foam.
